(19) United States
(12) Patent Application Publication
(10) Pub. No.: US 2010/0164314 A1
(43) Pub. Date: Jul. 1, 2010

(54) MOTOR

(75) Inventor: Toshio UENO, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/647,751

(22) Filed: Dec. 28, 2009

(30) Foreign Application Priority Data
Dec. 26, 2008 (JP) 2008-334720

(51) Int. Cl. H02K 5/16

(52) U.S. Cl. 310/90

(57) ABSTRACT

A motor may include a rotation shaft, a bearing for supporting a shaft end of the rotation shaft, a bearing holder for supporting the bearing, and an urging member provided with a spring part for urging the bearing toward the rotation shaft. The urging member is slid in a mounting direction intersecting the motor axial line direction to be mounted on the bearing holder. The urging member includes a bottom plate part, a side plate part protruded from the bottom plate part and a hook part engaged with the bearing holder. A detachment prevention mechanism is provided for preventing the urging member from detaching from the bearing holder and the detachment prevention mechanism is provided with an engaging projection protruded from the hook part and an engaging recessed part recessed from a front end face of the bearing holder.

### CROSS REFERENCE TO RELATED APPLICATION

The present invention claims priority under 35 U.S.C. §119 to Japanese Application No. 2008-334720 filed Dec. 26, 2008, the entire content of which is incorporated herein by reference.

### FIELD OF THE INVENTION

An embodiment of the present invention may relate to a motor. More specifically, an embodiment of the present invention may relate to a motor provided with an urging member for urging a bearing toward a shaft end of a rotation shaft.

### BACKGROUND OF THE INVENTION

A stepping motor generally includes a rotor, which is provided with a permanent magnet on an outer peripheral face of a rotation shaft, and a ring shaped stator which faces an outer peripheral face of the permanent magnet through a gap space, and the motor is structured so that a shaft end of the rotation shaft is supported by a bearing. In this motor, the bearing is often held movably in a motor axial line direction by a through hole for bearing formed in a bearing holder and a rear end face of the bearing is urged toward the rotation shaft by a spring part of the urging member which is disposed on a rear side of the bearing.

In order to structure this type of motor, when the urging member is fitted to the bearing holder in the motor axial line direction from the rear side of the bearing holder and pawl parts protruded forward from the urging member are engaged with the bearing holder and, in addition, when the size of the motor is reduced, the pawl parts are required to be made smaller and thus the urging member may be easily detached from the bearing holder.

In order to prevent this problem, a structure has been proposed in which the urging member is slid in a mounting direction intersecting the motor axial line direction to mount the urging member on the bearing holder (see Japanese Patent Laid-Open No. 2007-202388).

Further, in the above-mentioned Patent Reference, a motor is proposed which includes a detachment preventing structure for preventing the urging member from detaching from the bearing holder. In other words, the urging member is formed with an engaging hook protruded forward from a bottom plate part which is superposed on the rear end face of the bearing holder and the rear end face of the bearing holder is formed with an engaging hole. The engaging hook of the urging member is engaged with the engaging hole of the bearing holder to prevent the urging member from sliding in an opposite direction to the mounting direction of the urging member and from detaching from the bearing holder.

However, in the detachment preventing structure described in the above-mentioned Patent Reference, when the size of the motor is further reduced, the rear end face of the bearing holder and the bottom plate part of the urging member becomes smaller or narrower. Therefore, it becomes difficult that the engaging hole and the engaging hook for preventing detachment are formed in the rear end face of the bearing holder and the bottom plate part of the urging member and thus it is difficult to surely prevent the urging member from detaching from the bearing holder.

### SUMMARY OF THE INVENTION

In view of the problem described above, at least an embodiment of the present invention may advantageously provide a motor which is capable of surely preventing the urging member from detaching from the bearing holder even when the size of the motor is reduced.

According to at least an embodiment of the present invention, there may be provided a motor including a rotation shaft which is extended in a motor axial line direction, a bearing which supports a shaft end of the rotation shaft, a bearing holder which is formed with a through hole for bearing for movably supporting the bearing in the motor axial line direction, and an urging member which is provided with a spring part for urging a rear end face of the bearing toward the rotation shaft. In this motor, when the urging member is slid in a mounting direction intersecting the motor axial line direction to be mounted on the bearing holder, the urging member includes a bottom plate part which is superposed on a rear end face of the bearing holder, a side plate part which is protruded toward a front side from the bottom plate part to be superposed on the side face of the bearing holder, and a hook part which is bent toward an inner side from a tip end side of the side plate part to be engaged with a front end face of the bearing holder. Further, a detachment prevention mechanism for preventing the urging member from detaching from the bearing holder toward an opposite side to the mounting direction of the urging member is structured between the hook part and the bearing holder, and the detachment prevention mechanism is provided with an engaging projection, which is protruded toward a rear side from the hook part, and an engaging recessed part which is recessed from the front end face of the bearing holder and to which the engaging projection is fitted.

In accordance with an embodiment of the present invention, when the urging member is to be mounted, the urging member is slid in a mounting direction intersecting the motor axial line direction while the side plate part protruding toward the front side from the bottom plate part of the urging member is utilized as a guide, and the hook part which is bent toward the inner side from the side plate part of the urging member is superposed on the front end face of the bearing holder. Therefore, different from a case that the urging member is pressed against the bearing holder in the motor axial line direction to be engaged with the bearing holder, even when the urging member and the bearing holder are made smaller with downsizing of the motor, a larger hook part is formed and thus the urging member is firmly mounted on the bearing holder. Accordingly, even when a force in the motor axial line “L” direction is applied to the urging member so that the urging member is to be separated from the bearing holder, the urging member is not detached from the bearing holder. Further, in accordance with the embodiment of the present invention, a detachment prevention mechanism is structured between the hook part of the urging member and the bearing holder. Therefore, even when the bottom plate part of the urging member and the rear end face of the bearing holder are formed narrower as the size of the motor is reduced, the detachment prevention mechanism is structured. Moreover, the detachment prevention mechanism is structured of the engaging projection protruded toward a rear side from the hook part and the engaging recessed part which is recessed from the front end face of the bearing holder and thus, when viewed in the motor axial line direction, the area which is occupied by the detachment prevention mechanism is smaller. Therefore, even when the shape or the size of the hook part is restricted because the size of the motor is reduced, the detachment prevention mechanism is structured. Accordingly, even when the size of the motor is reduced, detachment of the urging member from the bearing holder is prevented surely.

In accordance with an embodiment of the present invention, the engaging projection is provided with elasticity so as to be elastically deformable in the motor axial line direction. According to this structure, when the urging member is slid in the mounting direction intersecting the motor axial line direction to be mounted on the bearing holder, the engaging projection does not obstruct the mounting operation. In addition, when the urging member is slid in the mounting direction intersecting the motor axial line direction to be mounted on the bearing holder, the engaging projection is automatically fitted to and engaged with the engaging recessed part.

In accordance with an embodiment of the present invention, the motor includes a stator to which the front end face of the bearing holder is fixed. The front end face of the bearing holder is recessed on both sides of the through hole for bearing so that engagement stepped parts are formed on the bearing holder and spaces are formed between the stator and the engagement stepped parts of the bearing holder, and the engaging recessed part is formed by further recessing a part of the engagement stepped part. Further, the side plate part of the urging member is provided with two hook parts, which are protruded from both sides of the bottom plate part to be engaged with the engagement stepped parts formed on both sides of the bearing holder, and each of the engaging projections protruded from the hook parts is fitted into each of the engaging recessed parts. According to this structure, a structure in which the engaging projection is fitted into the engaging recessed part is easily attained on both of the side plate parts of the urging member and thus the urging member is surely prevented from detaching from the bearing holder.

In accordance with an embodiment of the present invention, the engaging projection is protruded obliquely from the hook part toward the opposite side to the mounting direction of the urging member. According to this structure, when the urging member is slid in the mounting direction intersecting the motor axial line direction to be mounted on the bearing holder, the engaging projection does not obstruct the mounting operation. In addition, after the urging member has been mounted on the bearing holder, even when the urging member is going to slide toward the opposite side to the mounting direction so as to be detached from the bearing holder, the engaging projection generates a large resistance force. Therefore, detachment of the urging member from the bearing holder is surely prevented. Further, in accordance with an embodiment of the present invention, the through hole for bearing of the bearing holder is formed at a position displaced toward one side from a center of the bearing holder so that, when the bearing holder is fixed to the stator, a part of the rear end face of the stator is exposed, and the urging member is mounted from the exposed rear end face side of the stator. According to this structure, the exposed rear end face of the stator is utilized as a guide when the urging member is to be mounted and thus mounting operation is easily performed.

In accordance with an embodiment of the present invention, the engaging recessed part is provided on the opposite side to the mounting direction of the urging member with an internal corner part into which a tip end part of the engaging projection is entered. According to this structure, even when the urging member is going to slide toward the opposite side to the mounting direction to cause to be detached from the bearing holder, the engaging projection is caught by the internal corner part to generate a large resistance force. Therefore, detachment of the urging member from the bearing holder is surely prevented.

In accordance with an embodiment of the present invention, the engaging recessed part is formed at a separated position from the through hole for bearing. According to this structure, a thicker wall is interposed between the engaging recessed part and the through hole for bearing and the thicker is not deformed. Therefore, since the through hole for bearing is not deformed, the bearing is satisfactorily held by the through hole.

In accordance with an embodiment of the present invention, a positioning stopper is provided for determining a mounting position of the urging member with respect to the bearing holder when the urging member and the bearing holder are abutted with each other in the mounting direction. According to this structure, when the urging member is slid to be mounted on the bearing holder, the urging member is not detached from the bearing holder. Further, the urging member is mounted on the bearing holder with a high degree of positional accuracy.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(a) is a front view showing a motor in accordance with an embodiment of the present invention in which an upper half part is expressed as a cross sectional view, FIG. 1(b) is a right side view showing the motor, and FIG. 1(c) is an enlarged cross-sectional view showing a bearing portion on a base end side of the motor.

FIGS. 2(a) and 2(b) are explanatory views showing a bearing disposed on a base end side which is used in a motor in accordance with an embodiment of the present invention.

FIGS. 3(a), 3(b) and 3(c) are explanatory views showing a mounting method of an urging member on a bearing holder in a motor in accordance with an embodiment of the present invention.

FIGS. 4(a) through 4(f) are explanatory views showing an urging member which is used in a motor in accordance with an embodiment of the present invention.

FIGS. 5(a) through 5(e) are explanatory views showing a bearing holder which is used in a motor in accordance with an embodiment of the present invention.

FIG. 6 is a cross-sectional view showing an engaging recessed part formed in a bearing holder which is used in a motor in accordance with an embodiment of the present invention.

### DETAILED DESCRIPTION OF THE PREFERRED EMBODIMENTS

A motor in accordance with an embodiment of the present invention will be described below with reference to the accompanying drawings.

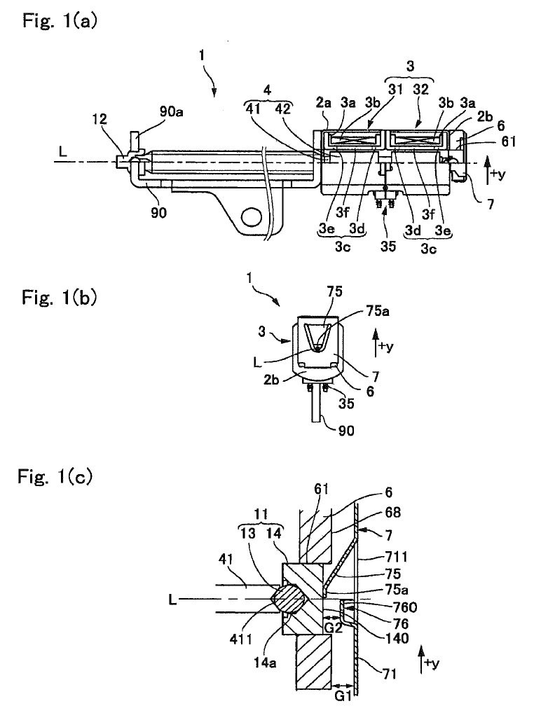

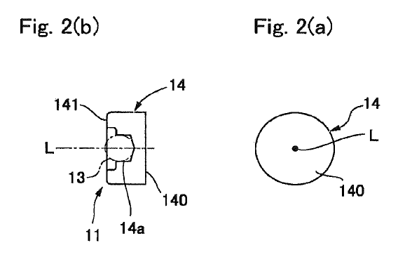

FIGS. 1(a), 1(b) and 1(c) are explanatory views showing a motor to which the present invention is applied. FIG. 1(a) is a front view showing a motor whose upper half part is expressed as a cross sectional view, FIG. 1(b) is a right side view showing the motor, and FIG. 1(c) is an enlarged cross-sectional view showing a bearing portion disposed on a base end side of the motor. FIGS. 2(a) and 2(b) are explanatory views showing a bearing on a base end side which is used in a motor to which the present invention is applied. FIG. 2(a) is a bottom view showing the bearing which is viewed from a rear side (opposite-to-output side) of a motor axial line direction and FIG. 2(b) is a longitudinal sectional view showing the bearing.

A motor 1 shown in FIGS. 1(a) and 1(b) is a small type of stepping motor which is used in an ODD (optical disk drive device) or the like. The motor 1 includes a tube-shaped stator 3 which is structured of two stator assemblies 31 and 32 superposed on each other in a motor axial line “L” direction. Each of the stator assemblies 31 and 32 includes a ring shaped drive coil 3b, which is wound around an insulator 3a, and a pair of stator cores 3c which is disposed on both sides in the motor axial line “L” direction of the drive coil 3b. The stator core 3c is comprised of an inner core 3d and an outer core 3e. Each of the inner core 3d and the outer core 3e is provided with a plurality of pole teeth 3f juxtaposed in a circumferential direction along an inner peripheral face of the insulator 3a. The pole teeth 3f which are formed in the inner core 3d and the outer core 3e are disposed so as to be alternately juxtaposed in the circumferential direction of the drive coil 3b. The stator 3 includes cases 2a and 2b on outer sides of the stator assemblies 31 and 32 in a radial direction. Two terminal parts 35 are formed on outer peripheral sides of the stator assemblies 31 and 32 and coil ends of the drive coil 3b are connected with the terminal part 35. The terminal parts 35 are protruded from opening parts formed in the cases 2a and 2b. As shown in FIG. 1(b), opposite side face parts of the stator 3 are formed in a flat face when viewed in the motor axial line “L” direction and other side face parts are formed in a circular arc shape. The terminal parts 35 are located on one side of the circular arc parts of the stator 3.

An inner side of the stator 3 is disposed with a rotor 4 in which a rotor magnet 42 is mounted on an outer peripheral face on the base end side of the rotation shaft 41. “S”-poles and “N”-poles are alternately disposed in the circumferential direction on the outer peripheral face of the rotor magnet 42. Both shaft ends of the rotation shaft 41 are rotatably held by pivot bearing mechanisms 11 and 12 respectively.

As shown in FIGS. 1(a) and 1(c), the pivot bearing mechanism 11 includes a ball 13 made of metal or ceramic, a part of which is entered into a recessed part 411 formed on the shaft end on the base end side of the rotation shaft 41, and a bearing 14 which is made of resin, formed in a disk-like shape and is provided with a bottomed recessed part 14a for receiving the ball 13.

A bearing holder 6, which is formed in a substantially rectangular shape and provided with a through hole 61 for bearing, and an urging member 7, which is provided with a spring part 75, are disposed for the pivot bearing mechanism 11 at an end part on the base end side (opposite-to-output side) of the stator 3 which is an opposite side to a tip end side (output side) to which the rotation shaft 41 is extended. The bearing 14 is inserted into the through hole 61 of the bearing holder 6 so as to be movable in the motor axial line “L” direction, and the spring part 75 of the urging member 7 which is extended toward the inside of the through hole 61 for bearing is abutted with the rear end face 140 of the bearing 14 so as to urge the bearing 14 toward the rotation shaft 41. The bearing holder 6 is fixed to the case 2b by a method such as welding or adhesion. In the motor 1 structured as described above, the rear end face 140 of the bearing 14 is urged by the spring part 75 of the urging member 7 within the through hole 61 of the bearing holder 6 toward the front side where the rotation shaft 41 is located and thus the bearing 14 supports the rotation shaft 41 surely.

In this embodiment, in order to mount the urging member 7 on the bearing holder 6, as described below, the urging member 7 is slid in a mounting direction perpendicular to the motor axial line “L” direction, i.e., in the direction shown by the arrow “+y”. In this embodiment, the spring part 75 is extended from a position near an upper end of the urging member 7 toward obliquely below (direction opposite to the slide direction when the urging member 7 is mounted). The tip end part 75a of the spring part 75 is abutted with the rear end face 140 of the bearing 14 at a position displaced upward a little from the motor axial line “L” (displaced on a front side in the slide direction when the urging member 7 is mounted).

As shown in FIGS. 2(a) and 2(b), the bearing 14 is a resin molded product formed in a substantially circular cylindrical shape, and its front end face 141 is formed with a recessed part 14a and its rear end face 140 is formed in a flat face.

In FIG. 1(a), a frame 90 whose cross section is a “U”-shape is fixed to an end face on the tip end side of the stator 3. A pivot bearing mechanism 12 for receiving a shaft end on the tip end side of the rotation shaft 41 is held by an opposite plate part 90a of the frame 90 which faces the stator 3 through a certain distance. The pivot bearing mechanism 12 is also provided with a structure substantially similar to the pivot bearing mechanism 11. In the pivot bearing mechanism 11, the bearing holder 6 and the urging member 7 are used whose width dimension or length dimension is smaller in comparison with a size of the stator 3.

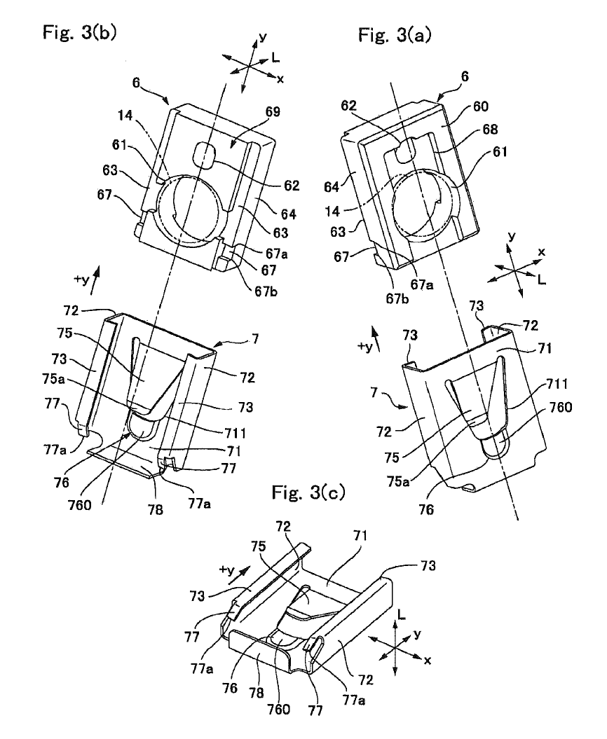

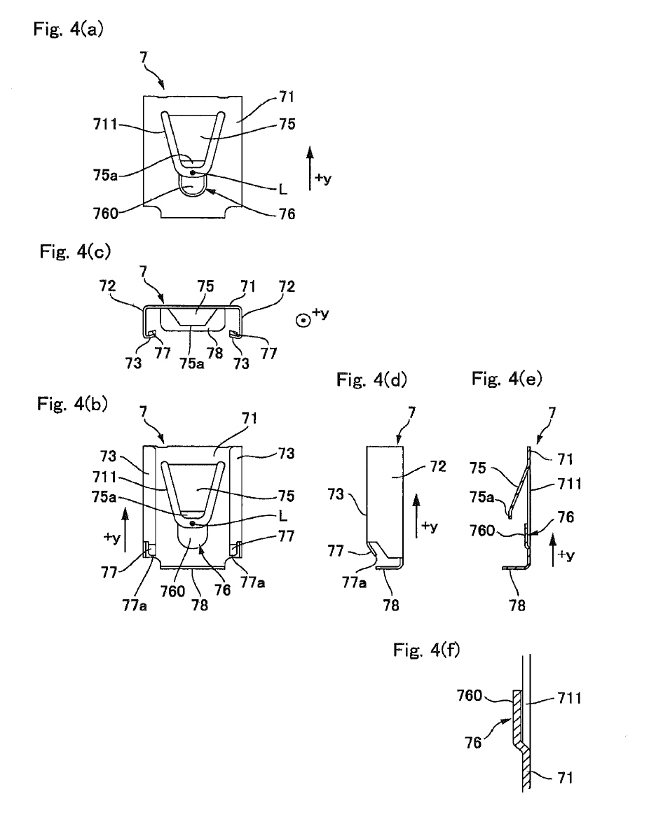

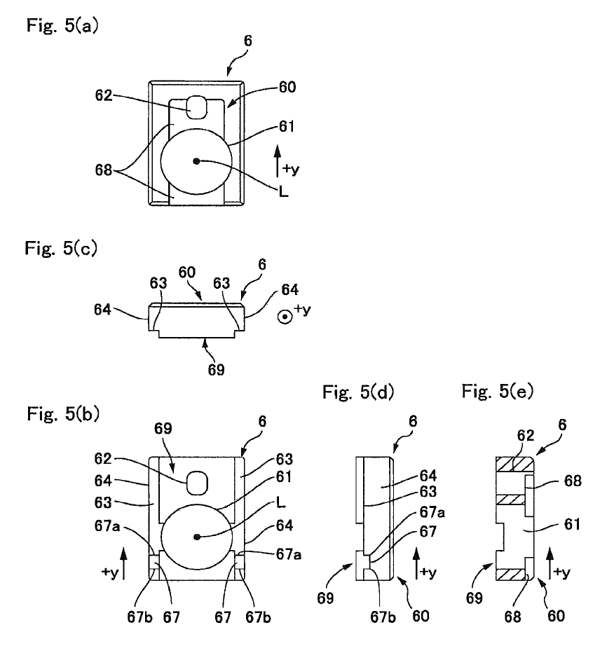

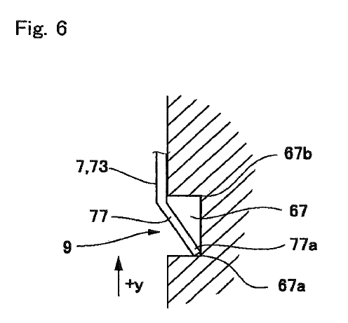

FIGS. 3(a), 3(b) and 3(c) arc explanatory views showing a method for mounting the urging member 7 on the bearing holder 6 in the motor 1 to which the present invention is applied. FIG. 3(a) is an explanatory view showing a state where the urging member is mounted on the bearing holder and which is viewed from an obliquely rear side. FIG. 3(b) is an explanatory view showing a state where the urging member is mounted on the bearing holder and which is viewed from an obliquely front side, and FIG. 3(c) is an explanatory view showing a front side of the urging member which is viewed from obliquely below. In FIGS. 3(a) and 3(b), the bearing 14 is shown by the alternate long and short dash line. FIGS. 4(a) through 4(f) are explanatory views showing the urging member 7 which is used in the motor 1 to which the present invention is applied. FIG. 4(a) is a bottom view showing the urging member 7 which is viewed from the rear side in the motor axial line “L” direction, FIG. 4(b) is its plan view which is viewed from the front side, FIG. 4(c) is its rear view which is viewed from an upper side, FIG. 4(d) is its side view, FIG. 4(e) is its cross-sectional view, and FIG. 4(f) is an enlarged partial sectional view. FIGS. 5(a) through 5(e) are explanatory views showing the bearing holder 6 which is used in the motor 1 to which the present invention is applied. FIG. 5(a) is a bottom view showing the bearing holder 6 which is viewed from the rear side in the motor axial line “L” direction, FIG. 5(b) is its plan view which is viewed from the front side, FIG. 5(c) is its rear view which is viewed from the upper side, FIG. 5(d) is its side view, and FIG. 5(e) is its cross-sectional view, FIG. 6 is a cross-sectional view showing an engaging recessed part 67 which is formed in the bearing holder 6 of the motor 1 to which the present invention is applied.

As shown in FIGS. 3(a) and 3(b), in this embodiment, in order to mount the urging member 7 on the bearing holder 6 which is fixed to the stator 3, the urging member 7 is fitted to the bearing holder 6 in an upper and lower direction (“y”-direction), not in a lateral direction (“x”-direction), which are perpendicular to the motor axial line “L” direction. Further, in this embodiment, the urging member 7 is mounted on the bearing holder 6 by means of that the urging member 7 is slid in an upward direction as shown by the arrow “+y”.

In order to adopt this mounting structure, the urging member 7 is formed of a metal plate which is worked into a predetermined shape so as to have elasticity. As shown in FIG. 3(a) through FIG. 4(f), the urging member 7 is provided with a bottom plate part 71 formed in a roughly rectangular shape, a spring part 75 which is cut in a tongue-like shape and bent obliquely from the bottom plate part 71, a pair of side plate parts 72, which are bent forward from respective opposite right and left side edge parts (long side portions) of the bottom plate part 71, and a pair of hook parts 73 which is inwardly bent from respective tip ends of a pair of the side plate parts 72. In this embodiment, the side plate part 72 is bent so as to be perpendicular to the bottom plate part 71 or bent a little larger than the right angle. As shown in FIG. 1(b), side face parts faced each other of the stator 3 are formed in a flat face, and a width in the lateral direction (“x”-direction) of the bottom plate part 71, i.e., a width between the side plate parts 72 are set to be smaller than a width between the side face parts of the stator 3. Therefore, when the urging member 7 is mounted on the bearing holder 6, a pair of the side plate parts 72 and a pair of hook parts 73 do not protrude outer sides in the lateral direction from the side face parts of the stator 3. The hook part 73 is bent a little larger than the right angle with respect to the side plate part 72 and an angle between the side plate part 72 and the hook part 73 is an acute angle. The tip end part 75a of the spring part 75 is bent a little so as to be substantially parallel to the bottom plate part 71.

Further, the urging member 7 is formed with a positioning stopper part 78 which is bent so as to protrude from a lower end part of the bottom plate part 71 toward the front side in the motor axial line “L” direction, in other words, toward the side where the bearing holder 6 is located. In this embodiment, since the urging member 7 is structured of a metal plate so as to have elasticity, a pair of the side plate parts 72, a pair of the hook parts 73 and the like in addition to the spring part 75 are also provided with elasticity respectively.

In addition, the urging member 7 is formed with engaging projections 77 which are bent so as to protrude from the hook parts 73 toward the rear side in the motor axial line “L” direction, in other words, toward the side where the bottom plate part 71 is located. In this embodiment, the engaging projection 77 is obliquely bent from an end part on the lower side in the longitudinal direction of the hook part 73 toward the bottom plate part 71. The engaging projection 77 structured as described above is also provided with elasticity and thus the engaging projection 77 is elastically deformable in the motor axial line “L” direction.

In addition, the bottom plate part 71 of the urging member 7 is formed with a bearing stopper part 76 which protrudes forward a little at a lower and adjacent position to a punching hole 711 for the spring part 75. The bearing stopper part 76 is a portion where an area including a lower end side in a circumferential edge of the punching hole 711 for the spring part 75 is protruded toward the front side. The bearing stopper part 76 is protruded toward the front side with a protruding dimension smaller than the spring part 75. A bottom part of the bearing stopper part 76 is formed in a flat plate part 760.

As shown in FIGS. 3(a) and 3(b) and FIGS. 5(a) through 5(e), the bearing holder 6 is a sintered body which is made of SUS and provided with a rectangular flat face shape whose size is capable of superposing the bottom plate part 71 of the urging member 7. The bearing holder 6 is formed with a circular through hole 61 for bearing at a position on a little lower side, in other words, at a lower position displaced from the center of the bearing holder 6. Therefore, when the bearing holder 6 is fixed to the case 2b which structures the rear end face of the stator 3, as shown in FIG. 1(b), a part of the rear end face of the case 2b is exposed on a lower end side of the bearing holder 6. A front end face 69 of the bearing holder 6 is formed with engagement stepped parts 63 along right and left side end parts (long side portion) opposite to each other, and a thickness of the bearing holder 6 is slightly made thinner through the engagement stepped part 63. The engagement stepped part 63 is set to form a space between the rear end face of the case 2b and the engagement stepped part 63 into which the hook part 73 of the urging member 7 is capable of being inserted when the front end face 69 of the bearing holder 6 is fixed to the case 2b of the stator 3. A width dimension of the engagement stepped part 63 is set to be a little wider than a width dimension of the hook parts 73 of the urging member 7. Further, thicknesses of both end portions of the bearing holder 6 which are made thinner by the engagement stepped parts 63 (thicknesses of the side faces 64) are substantially the same width dimension as those of the side plate parts 72 of the urging member 7. Further, the engagement stepped parts 63 are formed to be cut at positions where the through hole 61 for bearing is formed so that the engagement stepped parts 63 are connected with the through hole 61 and thus the width dimension of the bearing holder 6 can be reduced.

A shallow and wide width groove 68 is extended in the upper and lower direction on a substantially center area in the widthwise direction of the rear end face 60 of the bearing holder 6. The groove 68 is extended from the lower end part of the rear end face 60 of the bearing holder 6 toward the upper direction, and the through hole 61 for bearing is formed in its midway portion. A position adjusting through hole 62 is formed in the bearing holder 6 at a position located on an upper end edge of the groove 68. The position adjusting through hole 62 is utilized to perform positional adjustment by using a jig when the bearing holder 6 is fixed to the end part of the stator 3.

Further, engaging recessed parts 67 are formed at positions near the lower ends in the longitudinal direction of the engagement stepped parts 63 on the front end face 69 of the bearing holder 6 by means of that parts of the both engagement stepped parts 63 are further recessed. The engaging recessed part 67 is formed in a rectangular cross section. Therefore, as shown in FIG. 6, the engaging recessed part 67 is formed with internal corner parts 67a and 67b at a substantially right angle on both sides in the upper and lower direction. The engaging projection 77 formed in the hook part 73 of the urging member 7 is fitted into the engaging recessed part 67 and, in this manner, the detachment prevention mechanism 9 is structured for preventing the urging member 7 from detaching toward a side opposite to the mounting slide direction from the bearing holder 6.

A mounting structure of the urging member 7 on the bearing holder 6 will be described below while describing a manufacturing method for the motor 1 in this embodiment. In order to manufacture the motor 1 in this embodiment, as shown in FIG. 1(a), after the stator 3 and the rotor 4 have been assembled, the frame 90 is fixed to the stator 3. After that, the rotor 4 is inserted in the inside of the stator 3 and, in a state that a shaft end on the tip end side of the rotation shaft 41 is supported by the pivot bearing mechanism 12, the front end face 69 of the bearing holder 6 is fixed to the rear end face of the case 2b which is the end part of the stator 3. Spot welding, for example, may be utilized to perform this fixing.

Next, the ball 13 and the bearing 14 are mounted on the through hole 61 for bearing of the bearing holder 6 from the rear side to dispose the bearing 14 in the through hole 61 for bearing. This state is represented as shown in FIG. 1(c).

Next, as shown in FIG. 1(c) and FIGS. 3(a) and 3(b), the urging member 7 is made slide from the lower side in a mounting direction intersecting the motor axial line “L” direction, in this embodiment, in the direction perpendicular to the motor axial line “L” direction. As a result, the bottom plate part 71 of the urging member 7 is superposed on the rear end face 60 of the bearing holder 6, the side plate parts 72 of the urging member 7 are superposed on the side faces 64 of the bearing holder 6, and the hook parts 73 are superposed on the engagement stepped parts 63 formed on the front end face 69 of the bearing holder 6. In this case, the side faces 64 of the bearing holder 6 function as guides for the side plate parts 72 of the urging member 7 and the engagement stepped parts 63 function as guides for the hook parts 73. Further, as shown in FIG. 1(b), the rear end face of the case 2b is exposed on the lower end side of the bearing holder 6, i.e., on the side from which the urging member 7 is mounted. Therefore, the hook part 73 of the urging member 7 is capable of being inserted into the space between the rear end face of the case 2b and the engagement stepped part 63 by utilizing the exposed rear end face of the case 2b as a guide.

After that, the positioning stopper part 78 is abutted with the lower end face of the bearing holder 6 and the engaging projections 77 protruded toward the rear side from the hook parts 73 of the urging member 7 are fitted into the engaging recessed parts 67 which are formed on the engagement stepped parts 63 of the bearing holder 6. As a result, as shown in FIG. 6, the tip end part 77a of the engaging projection 77 is positioned at the internal corner part 67a which is formed on the opposite side to the mounting direction in the engaging recessed part 67.

In this state, the bottom plate part 71 of the urging member 7 is superposed on the rear end face 60 of the bearing holder 6 and the spring part 75 urges the rear end face 140 of the bearing 14 toward the rotation shaft 41. This state is maintained by means of that the bearing holder 6 is elastically sandwiched by the hook parts 73 and the bottom plate part 71. Further, the side plate parts 72 are also elastically deformed and their shape returning forces act as forces for maintaining the state where the urging member 7 is held to the bearing holder 6.

In this embodiment, the positioning stopper part 78 is also abutted with the lower end face of the bearing holder 6 to be elastically deformed. Therefore, the positioning stopper part 78 is going to make the urging member 7 slide in the opposite direction to the mounting direction but the slide movement is prevented by engagement of the engaging projections 77 with the engaging recessed parts 67.

Further, after the motor 1 has been assembled, even when a force is applied that is going to make the urging member 7 slide in the opposite direction to the mounting direction, the slide movement is prevented by engagement of the engaging projections 77 with the engaging recessed parts 67. In this manner, in this embodiment, the detachment prevention mechanism 9 for preventing the urging member 7 from detaching from the bearing holder 6 toward the opposite side to the mounting direction of the urging member 7 is structured by the engaging projections 77 and the engaging recessed parts 67 between the hook parts 73 and the bearing holder 6,

In this state, since the groove 68 is formed on the rear end face 60 of the bearing holder 6, as shown in FIG. 1(c), a gap space “G1” is formed in the motor axial line “L” direction between the rear end face 60 of the bearing holder 6 and the bottom plate part 71 of the urging member 7. Therefore, since the spring part 75 of the urging member 7 and the bearing holder 6 do not interfere with each other, the spring part 75 can be formed in an optimum structure in consideration of its elasticity and the like.

Further, a gap space “G2” is formed in the motor axial line “L” direction between the rear end face 140 of the bearing 14 and the bearing stopper part 76 which is formed in the bottom plate part 71 of the urging member 7. Therefore, the bearing 14 is capable of being displaced to some extent toward the rear side in the motor axial line “L” direction and thus, even when a force toward the rear side in the motor axial line “L” direction is applied to the rotation shaft 41, the force is absorbed. Further, even when an excessive force toward the rear side in the motor axial line “L” direction is applied to the rotation shaft 41 to cause the bearing 14 to displace toward the rear side, the displacement is prevented by means of that the rear end face 140 of the bearing 14 is abutted with the bearing stopper part 76. In this manner, in this embodiment, the displacement range toward the rear side in the motor axial line “L” direction of the bearing 14 is restricted. Therefore, an appropriate displaceable amount of the bearing 14 is secured in the motor axial line “L” direction.

As described above, in the motor 1 in this embodiment, when the urging member 7 is to be mounted on the bearing holder 6, the urging member 7 is made slide in the mounting direction intersecting the motor axial line “L” direction to superpose the bottom plate part 71 of the urging member 7 on the rear end face 60 of the bearing holder 6 and to engage the hook parts 73 with the engagement stepped parts 63 of the bearing holder 6. Therefore, different from a case that the urging member 7 is pressed against the bearing holder 6 in the motor axial line “L” direction to be engaged, even when a large space is not secured for a portion where the urging member 7 is engaged as the size of the motor 1 is reduced or, even when the bearing holder 6 is very thinner like this embodiment, the urging member 7 is firmly held by the bearing holder 6. Accordingly, even when a force in the motor axial line “L” direction is applied to the urging member 7 so as to separate the urging member 7 from the bearing holder 6 in the state that the urging member 7 has been mounted on the bearing holder 6, positional displacement or detachment of the urging member 7 is prevented.

Further, the engaging projection 77 of the urging member 7 which is protruded toward the rear side from the hook part 73 is fitted into the engaging recessed part 67 which is formed on the engagement stepped part 63 of the bearing holder 6. Therefore, even when a force is applied to the urging member 7 for sliding it in the reverse direction to its mounting direction, slide in the reverse direction of the urging member 7 is prevented by the detachment prevention mechanism 9 which is structured of the engaging projection 77 and the engaging recessed part 67. Accordingly, positional displacement of the urging member 7 and detachment of the urging member 7 are prevented.

Further, in this embodiment, the detachment prevention mechanism 9 is structured between the hook parts 73 of the urging member 7 and the bearing holder 6 and thus, even when the width dimensions of the bottom plate part 71 of the urging member 7 and the rear end face 60 of the bearing holder 6 are set to be smaller or narrower, the detachment prevention mechanism 9 is structured. Moreover, the detachment prevention mechanism 9 is structured of the engaging projection 77 protruded toward the rear side from the hook part 73 and the engaging recessed part 67 recessed from the front end face 69 of the bearing holder 6 and thus, when viewed in the motor axial line “L” direction, the area which is occupied by the detachment prevention mechanism 9 is smaller. Therefore, even when the shape of the hook part 73 is restricted because the size of the motor 1 is reduced, the detachment prevention mechanism 9 is structured. Accordingly, in accordance with this embodiment, even when the size of the motor 1 is reduced, detachment of the urging member from the bearing holder is prevented surely.

Further, the engaging projection 77 is provided with elasticity which is elastically deformable in the motor axial line “L” direction. Therefore, when the urging member 7 is slid in the mounting direction intersecting the motor axial line “L” direction to be mounted on the bearing holder 6, the engaging projection 77 does not obstruct the mounting operation. Further, when the urging member 7 is slid in the mounting direction to be mounted on the bearing holder 6, the engaging projection 77 is automatically fitted to and engaged with the engaging recessed part 67.

Moreover, the engaging projection 77 is obliquely protruded from the hook part 73 toward the opposite side to the mounting direction when the urging member 7 is slid and mounted. Therefore, when the urging member 7 is slid in the mounting direction intersecting the motor axial line “L” direction to be mounted on the bearing holder 6, the engaging, projection 77 does not obstruct the mounting operation. In addition, even when the urging member 7 is going to slide toward the opposite side to the mounting direction to be detached from the bearing holder 6, the engaging projection 77 generates a large resistance force. Therefore, detachment of the urging member 7 from the bearing holder 6 is surely prevented. Further, the engaging projection 77 is elastically engaged with the engaging recessed part 67 and thus, even when some external force is applied to deform the engaging projection 77, the engaging projection 77 is returned, to its original shape. Therefore, the engaging projection 77 and the engaging recessed part 67 are not damaged.

Further, the engaging recessed part 67 is provided with the internal corner part 67b on the opposite side to the mounting direction of the urging member 7 to which the tip end part 77a of the engaging projection 77 is fitted. Therefore, when the urging member 7 is going to slide toward the opposite side to the mounting direction so as to be detached from the bearing holder 6, the engaging projection 77 is engaged with the internal corner part 67b to generate a large resistance force. Accordingly, detachment of the urging member 7 from the bearing holder 6 is prevented surely.

Further, the engaging recessed part 67 of the bearing holder 6 is formed at a separated position from the through hole 61 for bearing. Therefore, a thicker wall is interposed between the engaging recessed part 67 and the through hole 61 for bearing and the thicker wall is not deformed. Therefore, since the through hole 61 for bearing is not deformed, the bearing 14 is satisfactorily held by the through hole 61,

Further, in the motor 1 in this embodiment, the bearing stopper part 76 protruding toward the front side with a smaller protruding dimension than the spring part 75 is structured in the bottom plate part 71 of the urging member 7. Therefore, displacement of the bearing 14 toward the rear side in the motor axial line “L” direction is restricted by the bearing stopper part 76. Accordingly, the bearing 14 is not displaced excessively and thus the spring part 75 is not damaged.

Further, the bearing stopper part 76 is protruded from the bottom plate part 71 of the urging member 7 and thus the rear end face 140 of the bearing 14 may be formed in a flat face and a conventional protruded part is not required on the rear end face 140. Therefore, the structure of the bearing 14 is simplified and a malfunction such that the protruded part formed on the rear end face 140 of the bearing 14 is caught by the spring part 75 to cause a damage of the spring part 75 does not occur. In addition, the rear end face 140 of the bearing 14 may be formed in a flat face and a conventional protruded part is not required and thus molding precision of the bearing 14 is improved.

Further, the bearing stopper part 76 is a portion where a region including a part of the circumferential edge of the punching hole 711 for the spring part 75 in the bottom plate part 71 is protruded toward the front side. Therefore, the bearing stopper part 76 is structured without adding another structural member or without performing a complicated working on the bottom plate part 71 of the urging member 7. Further, when the bearing stopper part 76 is formed by means of that a region including a part of the circumferential edge of the punching hole 711 for the spring part 75 in the bottom plate part 71 is protruded toward the front side, press working portions to the bottom plate part 71 can be reduced. Therefore, even when the bottom plate part 71 is formed narrower due to reduction of the size of the motor 1, the bottom plate part 71 is formed with the bearing stopper part 76 in addition to the spring part 75.

In addition, in this embodiment, the portion of the bearing stopper part 76 which is to be abutted with the rear end face 140 of the bearing 14 is formed to be the flat plate part 760 that is perpendicular to the motor axial line “L”. Therefore, even when the bearing stopper part 76 and the bearing 14 are abutted with each other, they are abutted with each other with a wide area and thus deformations of the bearing stopper part 76 and the rear end face 140 of the bearing 14 are prevented surely.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotation shaft which is extended in a motor axial line direction;
a bearing which supports a shaft end of the rotation shaft;
a bearing holder which is formed with a through hole for bearing for movably supporting the bearing in the motor axial line direction; and
an urging member which is provided with a spring part for urging a rear end face of the bearing toward the rotation shaft;
wherein when the urging member is slid in a mounting direction intersecting the motor axial line direction to be mounted on the bearing holder, the urging member comprises:
a bottom plate part which is superposed on a rear end face of the bearing holder;
a side plate part which is protruded toward a front side from the bottom plate part to be superposed on the side face of the bearing holder; and
a hook part which is bent toward an inner side from a tip end side of the side plate part and is engaged with a front end face of the bearing holder;
wherein a detachment prevention mechanism for preventing the urging member from detaching from the bearing holder toward an opposite side to the mounting direction of the urging member is structured between the hook part and the bearing holder; and
wherein the detachment prevention mechanism is provided with an engaging projection, which is protruded from the hook part toward a rear side, and an engaging recessed part which is recessed from the front end face of the bearing holder and to which the engaging projection is fitted.

2. The motor according to claim 1, wherein the engaging projection is provided with elasticity so as to be elastically deformable in the motor axial line direction.

3. The motor according to claim 2, wherein the engaging projection is protruded obliquely from the hook part toward the opposite side to the mounting direction of the urging member.

4. The motor according to claim 3, wherein the engaging recessed part is provided on the opposite side to the mounting direction of the urging member with an internal corner part into which a tip end part of the engaging projection is entered.

5. The motor according to claim 4, wherein the engaging recessed part is formed at a separated position from the through hole for bearing.

6. The motor according to claim 1, wherein the engaging projection is protruded obliquely from the hook part toward the opposite side to the mounting direction of the urging member.

7. The motor according to claim 6, wherein the engaging recessed part is provided on the opposite side to the mounting direction of the urging member with an internal corner part into which a tip end part of the engaging projection is entered.

8. The motor according to claim 2, wherein the engaging recessed part is formed at a separated position from the through hole for bearing.

9. The motor according to claim 1, further comprising a stator to which the front end face of the bearing holder is fixed,
wherein the front end face of the bearing holder is recessed on both sides of the through hole for bearing so that engagement stepped parts are formed on the bearing holder and spaces are formed between the stator and the bearing holder,
wherein two engaging recessed parts are formed by further recessing parts of the engagement stepped parts,
wherein the urging member is provided with two side plate parts having the hook part, which are protruded from both sides of the bottom plate part so that the, hook parts are engaged with the engagement stepped parts formed on both sides of the bearing holder, and
wherein each of the engaging projections protruded from the hook parts is fitted into each of the engaging recessed parts.

10. The motor according to claim 9, wherein the engaging projection is protruded obliquely from the hook part toward the opposite side to the mounting direction of the urging member.

11. The motor according to claim 10, wherein the engaging recessed part is provided on the opposite side to the mounting direction of the urging member with an internal corner part into which a tip end part of the engaging projection is entered.

12. The motor according to claim 10, wherein
the through hole for bearing of the bearing holder is formed at a position displaced toward one side from a center of the bearing holder so that, when the bearing holder is fixed to the stator, a part of the rear end face of the stator is exposed, and
the urging member is mounted from an exposed rear end face side of the stator.

13. The motor according to claim 1, further comprising a positioning stopper for determining a mounting position of the urging member with respect to the bearing holder when the urging member and the bearing holder are abutted with each other in the mounting direction.
